(19) United States
(12) Patent Application Publication
(10) Pub. No.: US 2005/0087086 A1
(43) Pub. Date: Apr. 28, 2005

(54) Sheet-fed printing press having a dryer

(76) Inventors: Jochen Jung, Sandhausen (DE); Rudolf Leib, Wiesloch (DE); Alexander Weber, Weinheim (DE)

Correspondence Address: LERNER AND GREENBERG, PA, P O BOX 2480, HOLLYWOOD, FL, 33022-2480, US

(21) Appl. No.: 10/960,127

(22) Filed: Oct. 7, 2004

(30) Foreign Application Priority Data
Oct. 27, 2003 (DE) 103 50 109.6

(51) Int. Cl. B41F 23/04

(52) U.S. Cl. 101/424.1

(57) ABSTRACT

A sheet-fed printing press contains a dryer that is oriented at a cylinder and has a concave contour that is adapted to the cylinder. The dryer is subdivided into a blower part and an air guiding part. The concave contour is formed on the air guiding part and the blower part is mounted so as to be displaceable relative to the air guiding part.

### BACKGROUND OF THE INVENTION

### FIELD OF THE INVENTION

The present invention relates to a sheet-fed printing press, having a dryer that is oriented at a cylinder and has a concave contour that is adapted to the cylinder. A sheet-fed printing press of this type is shown in a drawing in Published, Non-Prosecuted German Patent Application DE 30 01 355 A1 corresponding to U.S. Pat. No. 4,312,137. The dryer of the sheet-fed printing press is clearly installed in a manner fixed to the press and is therefore a hindrance during press maintenance.

### SUMMARY OF THE INVENTION

It is accordingly an object of the invention to provide a sheet-fed printing press having a dryer that overcomes the above-mentioned disadvantages of the prior art devices of this general type, that is relatively easy to maintain.

With the foregoing and other objects in view there is provided, in accordance with the invention, a sheet-fed printing press. The printing press contains a cylinder and a dryer oriented at the cylinder and has a concave contour adapted to the cylinder. The dryer is subdivided into a blower part and an air guiding part. The concave contour is formed on the air guiding part and the blower part is mounted so as to be displaceable relative to the air guiding part.

The advantage associated with the invention can be seen in the fact that it is possible to remove the blower part from the sheet-fed printing press by its displacement relative to the air guiding part, as a result of which access to the interior of the press that is necessary for maintenance purposes can be facilitated.

The concave contour can be polygonally concave and is preferably a concave curve, for example in the shape of a circular arc.

In one development that is advantageous with regard to further improvement of the easy maintenance of the sheet-fed printing press, the air guiding part is mounted so as to be displaceable relative to the cylinder into an active position and a passive position as desired.

In one development that is advantageous with regard to multifunctional use of the air guiding part, the air guiding part is configured to be substantially grid-shaped.

Other features which are considered as characteristic for the invention are set forth in the appended claims.

Although the invention is illustrated and described herein as embodied in a sheet-fed printing press having a dryer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a sheet-fed printing press having a dryer; and

FIG. 2 is a diagrammatic, plan view of an air guiding part of the dryer.

### DESCRIPTION OF THE PREFERRED EMBODIMENTS

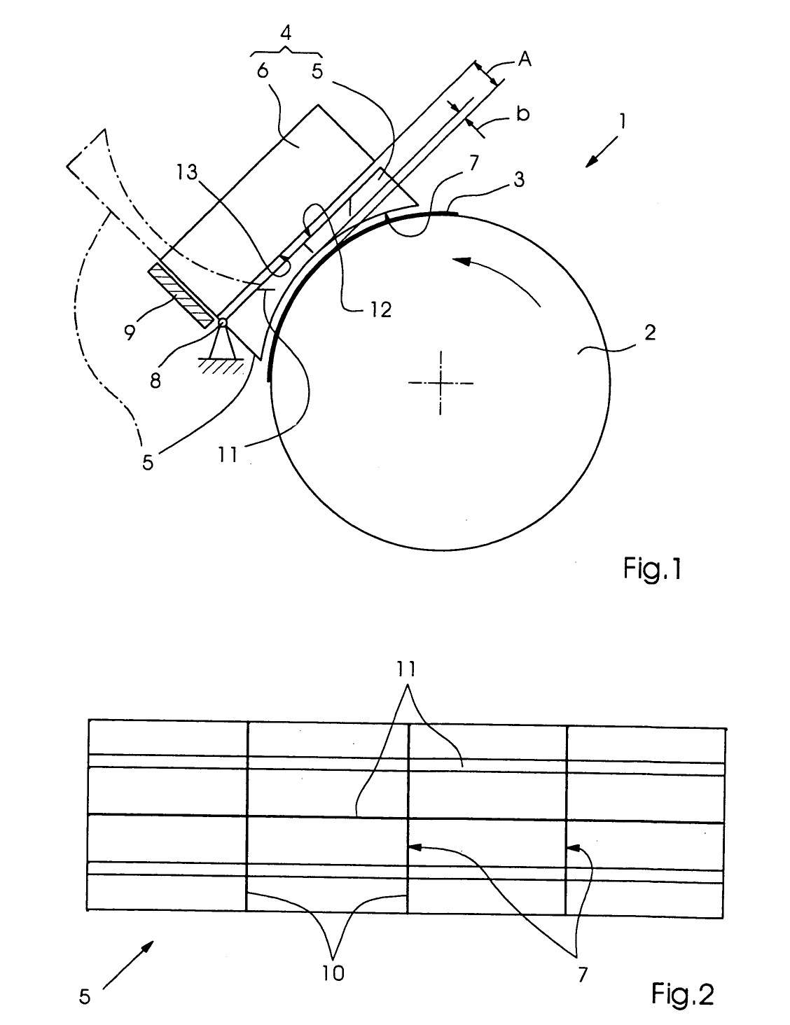

Referring now to the figures of the drawing in detail and first, particularly, to FIG. 1 thereof, there is shown a detail of a sheet-fed printing press 1. The detail shows a cylinder 2 having a printing material sheet 3 lying on it, and a dryer 4 for drying the printing material sheet 3 that is transported past the dryer 4 by the cylinder 2. The cylinder 2 is the impression cylinder of a printing unit for lithographic offset printing. The dryer 4 is a hot-air/infrared combined dryer and contains an air guiding part 5, which is permanently attached to a machine frame of the sheet-fed printing press 1, and a modular blower part 6.

The air guiding part 5 has a concave contour 7 that is concentric with respect to the circumference of the cylinder 2, and is mounted so as to be displaceable by a rotary joint or pivot 8 from an active position close to the cylinder 2 into a passive position at a distance from the cylinder 2. The cylinder 2 can be exposed for maintenance purposes by pivoting the air guiding part 5 into the passive position that is indicated in FIG. 1 with a phantom line.

The blower part 6 can be pushed into the sheet-fed printing press 1 or pulled out of the latter as a sliding carriage or roller carriage along a linear guide 9 in the form of a cross-member or rail in a direction parallel to the rotational axis of the cylinder 2. The blower part 6 is therefore a slide-in unit that can be locked in the sheet-fed printing press 1 and can be removed from the latter without tools. On account of its fixed arrangement on the frame, the air guiding part 5 remains in the sheet-fed printing press 1 during the removal of the blower part 6.

If the blower part 6 is inserted in the sheet-fed printing press 1 and the air guiding part 5 is located in its active position between the blower part 6 and the cylinder 2, a large spacing A between the blower part 6 and the printing material sheet 3 transported by the cylinder 2 is at least 40 millimeters and at most 150 millimeters, and a small spacing b between the concave contour 7 and the printing material sheet 3 is at least 10 millimeters and at most 40 millimeters. With regard to a good sealing action and the achievement of a high level of efficiency, it is advantageous to keep the spacing b this small.

During printing operation, the air guiding part 5 not only serves to direct the hot air ejected by the blower part 6 onto the printing material sheet 3 with particular accuracy, it also serves to suppress fluttering effects of the printing material sheet 3. Here, the air guiding part 5 acts as a sheet guiding element and its arcuate concave contour 7 guides the printing material sheet 3, which is gripped by the cylinder 2 at the sheet leading edge, or guides its sheet trailing edge.

It can be seen from FIG. 2 that the air guiding part 5 is composed of longitudinal webs 10 and transverse webs 11 in the manner of a skeletal structure. The longitudinal webs 10 are longitudinally oriented parallel to the running direction of the printing material sheet 3, and the transverse webs 11 are longitudinally oriented perpendicularly to the sheet running direction or parallel to the rotational axis of the cylinder 2. The concave contour 7 is formed on the longitudinal webs 10 which protrude beyond the transverse webs 11 in the direction of the cylinder 2.

The webs 10, 11 which form the frame of the air guiding part 5 are lamellar and are composed of silvered sheet metal, in order to reflect the infrared radiation emitted by the infrared source in the blower part 6 and direct it onto the printing material sheet 3. The silvered air guiding element 5 therefore ensures that the adjacent components (not shown in the drawing) disposed above and below the dryer 4 are shielded, in order to protect them against thermal or infrared radiation. In principle, the part denoted by the designation 5 is a multifunctional guiding element for dryer blown air, printing material sheet and IR radiation.

A connecting face 12 of the air guiding part 5 and a connecting face 13 of the blower part 6 are contoured so as to be compatible with one another, and are joined to one another during printing operation with a much tighter fit (practically without a gap) than FIG. 1, which serves primarily to clarify the subdivision of the dryer 4, suggests.

This application claims the priority, under 35 U.S.C. § 119, of German patent application No. 103 50 109.6, filed Oct. 27, 2003; the entire disclosure of the prior application is herewith incorporated by reference.

1. A sheet-fed printing press, comprising:
a cylinder; and
a dryer oriented at said cylinder and having a concave contour adapted to said cylinder, said dryer subdivided into a blower part and an air guiding part, said concave contour being formed on said air guiding part and said blower part mounted so as to be displaceable relative to said air guiding part.

2. The sheet-fed printing press according to claim 1, wherein said air guiding part is mounted so as to be displaceable relative to said cylinder into an active position and a passive position as desired.

3. The sheet-fed printing press according to claim 1, wherein said air guiding part is configured to be substantially grid-shaped.
